(19) United States
(12) Patent Application Publication
(10) Pub. No.: US 2026/0331333 A1
(43) Pub. Date: Oct. 22, 2026

(54) SHIELDED SOLID ELECTRIC WIRE AND METHOD FOR MANUFACTURING SHIELDED SOLID ELECTRIC WIRE

(71) Applicant: YAZAKI CORPORATION, Tokyo (JP)

(72) Inventors: Mizuki Shirai, Susono-shi (JP); Yukito Aoyama, Susono-shi (JP); Hayato Ikeya, Susono-shi (JP); Hiroki Kondo, Susono-shi (JP)

(21) Appl. No.: 19/572,868

(22) Filed: Mar. 20, 2026

(30) Foreign Application Priority Data
Apr. 18, 2025 (JP) 2025-068584

(51) Int. Cl. H01B 7/29; H01B 1/02; H01B 7/02; H01B 7/20; H01B 13/004

(52) U.S. Cl. CPC H01B 7/292; H01B 1/02; H01B 7/0216; H01B 7/20; H01B 13/004

(57) ABSTRACT

A shielded solid electric wire includes a solid electric wire including a solid core conductor made of a conductive metal and an insulator covering the solid core conductor; a conductive metal tube provided around the solid electric wire and made into a tubular shape having a burr formed during welding; and an inclusion provided between the solid electric wire and the metal tube and formed to include a material having a melting point higher than that of the insulator or an ignition point temperature of 250°C or higher.

### CROSS-REFERENCE TO RELATED APPLICATIONS

This application is based on and claims priority under 35 USC 119 from Japanese Patent Application No. 2025-068584 filed on Apr. 18, 2025, the contents of which are incorporated herein by reference.

### TECHNICAL FIELD

The present disclosure relates to a shielded solid electric wire and a method for manufacturing the shielded solid electric wire.

### BACKGROUND ART

In the related art, a shielded solid electric wire has been proposed which includes a solid core conductor having a predetermined rigidity or more, an insulating layer covering the solid core conductor, and a shield layer provided outside the insulating layer and crimped to the insulating layer (for example, see Patent Literature 1).

### CITATION LIST

### Patent Literature

Patent Literature 1: JP2023-517714A

### SUMMARY OF INVENTION

Here, the shielded solid electric wire as described above is manufactured by wrapping a plate-shaped metal plate around a solid electric wire, welding an overlapping portion where the metal plate overlaps, and then performing squeezing through a die. Further, in the above manufacturing method, there is a possibility that an insulator of the solid electric wire is damaged during the welding, and it is necessary to perform welding to avoid the damage, so that manufacturability is not good. Further, in the shielded solid electric wire manufactured through a metal plate welding step, a problem such as damage to the insulator caused by burrs generated during the welding may also occur.

The present disclosure has been made to solve such problems in the related art, and an object thereof is to provide a shielded solid electric wire capable of improving manufacturability and protecting an insulator even if burrs are generated during welding, and a method for manufacturing the shielded solid electric wire.

A shielded solid electric wire according to the present disclosure includes a solid electric wire including a solid core conductor made of a conductive metal and an insulator covering the solid core conductor; a conductive metal tube provided around the solid electric wire and made into a tubular shape having a burr formed during welding; and an inclusion provided between the solid electric wire and the metal tube and formed to include a material having a melting point higher than that of the insulator or an ignition point temperature of 250°C or higher.

A method for manufacturing a shielded solid electric wire according to the present disclosure includes forming a laminate by providing, on an outer periphery of a solid electric wire including a solid core conductor made of a conductive metal and an insulator covering the solid core conductor, an inclusion formed to include a material having a melting point higher than that of the insulator or an ignition point temperature of 250°C or higher; forming a laminated body by performing welding such that a metal plate is wrapped on the formed laminate to make the metal plate into a tubular shape; and compressing the formed laminated body inward from around the solid core conductor.

According to the present disclosure, it is possible to provide a shielded solid electric wire capable of improving manufacturability and protecting the insulator even if burrs are generated during welding, or a method for manufacturing the shielded solid electric wire.

### BRIEF DESCRIPTION OF DRAWINGS

FIG. 1 is a perspective view showing a shielded solid electric wire according to an embodiment of the present disclosure;

FIG. 2 is a cross-sectional view showing the shielded solid electric wire according to the embodiment of the present disclosure;

FIG. 3 is a cross-sectional view showing another example of the shielded solid electric wire according to the embodiment of the present disclosure; and

FIG. 4 is a process chart showing a method for manufacturing the shielded solid electric wire according to the present disclosure.

### DESCRIPTION OF EMBODIMENTS

Hereinafter, the present disclosure will be described with reference to a preferred embodiment. The present disclosure is not limited to the following embodiment, and may be appropriately modified without departing from the gist of the present disclosure. In the embodiment to be described below, there may be portions in which illustration and description of a part of a configuration are omitted, and it is needless to say that a known or well-known technique is appropriately applied to the details of an omitted technique within a range in which no contradiction with the contents to be described below occurs.

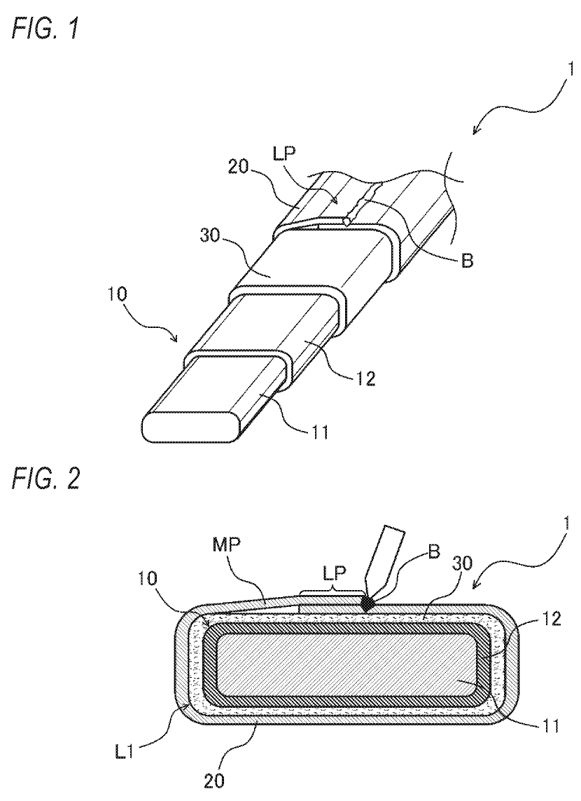

FIG. 1 is a perspective view showing a shielded solid electric wire according to an embodiment of the present disclosure, and FIG. 2 is a cross-sectional view showing the shielded solid electric wire according to the embodiment of the present disclosure. As shown in FIGS. 1 and 2, a shielded solid electric wire 1 according to the present embodiment includes a solid electric wire 10, a metal tube 20, and an inclusion 30.

The solid electric wire 10 is, for example, an electric wire for transmitting a large current, and includes a solid core conductor 11 and an insulator 12.

The solid core conductor 11 is a member made of a conductive metal such as copper or aluminum. The solid core conductor 11 is implemented by a busbar that is a flat metal plate. The solid core conductor 11 preferably has a predetermined rigidity and a cross-sectional area of 3 mm² or more and 300 mm² or less, more preferably 10 mm² or more, and still more preferably 100 mm² or more. In FIG. 1, the solid core conductor 11 is implemented by one metal plate, but may include a plurality of metal plates. When the solid core conductor 11 includes a plurality of metal plates, cross-sectional areas of the metal plates preferably satisfy the above condition. Further, the flat solid core conductor 11 has a substantially rectangular cross-section with rounded corners, but may have a rectangular cross-section with sharp angles without rounded corners.

The insulator 12 is an insulating member that covers the solid core conductor 11, and has a rectangular cross-section corresponding to a shape of the solid core conductor 11. Similar to the solid core conductor 11, the insulator 12 also has a substantially rectangular cross-section with rounded corners, but may have a rectangular cross-section with sharp angles.

The metal tube 20 is a conductive metal member provided around the solid electric wire 10, and exhibits a shielding function. The metal tube 20 is made of a conductive metal such as copper or aluminum. The metal tube 20 is made into a tubular shape to conform to a shape of the solid electric wire 10 having a rectangular cross-section.

The inclusion 30 is a member provided between the solid electric wire 10 and the metal tube 20. The inclusion 30 is formed to include a material having a melting point higher than that of the insulator 12 of the solid electric wire 10 or having an ignition point temperature of 250°C or higher. That is, when the inclusion 30 is formed to have a one-layer structure, the entire inclusion 30 is made of a material having a melting point higher than that of the insulator 12 or an ignition point temperature of 250°C or higher. Meanwhile, when the inclusion 30 is formed to have a structure of two or more layers, as long as an outermost layer of the inclusion 30 is made of a material having a melting point higher than that of the insulator 12 or an ignition point temperature of 250°C or higher, other layers may be made of another material. The inclusion 30 is attached to the insulator 12 over a length equal to or longer than at least the metal tube 20 in a longitudinal direction.

The inclusion 30 is preferably formed to include a material (for example, a resin film or a nonwoven fabric) having a Young's modulus lower than that of the insulator 12. Further, the inclusion 30 is preferably formed to include a material (for example, mica tape) having a heat-resistant temperature (a temperature at which ignition does not occur and melting does not occur) of 550°C or higher. Further, the inclusion 30 preferably has an outermost layer made of a material having a melting point higher than that of the insulator 12 or an ignition point temperature of 250°C or higher.

In such a shielded solid electric wire 1, the inclusion 30 is in contact with at least a part of an outer periphery of the insulator 12, and the metal tube 20 is in contact with at least a part of an outer periphery of the inclusion 30. It is preferable that the inclusion 30 is in contact with substantially an entire outer periphery (for example, 60% or more of the entire outer periphery) of the insulator 12 of the solid electric wire 10, and the metal tube 20 is in contact with substantially the entire outer periphery (for example, 60% or more of the entire outer periphery) of the inclusion 30. This is because, for example, when an operator grips the shielded solid electric wire 1, the inclusion 30 and the solid electric wire 10 are less likely to come off the metal tube 20. In order to realize such a contact relationship, the inclusion 30 preferably has a certain thickness and can be compressed, and for example, a nonwoven fabric is preferable.

In such a metal tube 20, as shown in FIG. 2, when the solid electric wire 10 and the inclusion 30 are made into a laminate L1, in a case where a width of a metal plate MP is larger than an outer peripheral length of the laminate L1, an overlapping portion LP where the wrapped metal plate MP overlaps is present. The metal tube 20 is formed in a tubular shape by performing welding at a location on the overlapping portion LP that is easily accessed by a welding machine. Here, burrs B are formed during the welding.

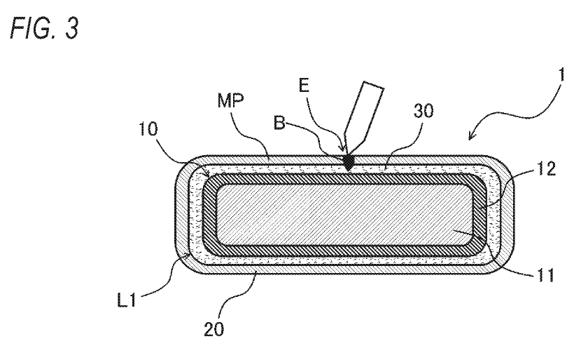

FIG. 3 is a cross-sectional view showing another example of the shielded solid electric wire 1 according to the embodiment of the present disclosure. When the width of the metal plate MP coincides with the outer peripheral length of the laminate L1, the overlapping portion LP of the metal plate MP is not present, and end portions E of the metal plate MP get into a state of facing and in contact with each other. In this case, the welding is performed between the end portions E of the metal plate MP in the contact state, the burrs B are formed between the end portions E, and the tubular shape is formed.

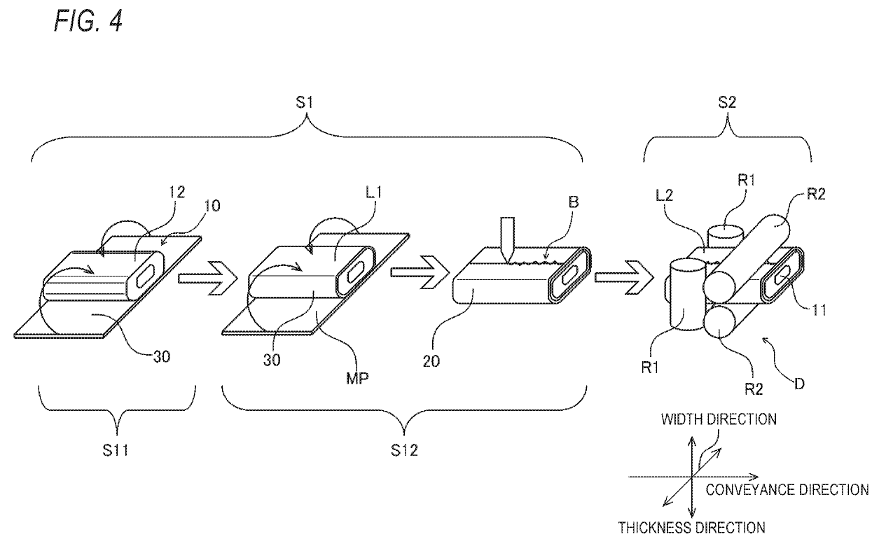

FIG. 4 is a process chart showing a method for manufacturing the shielded solid electric wire 1 according to the present disclosure. As shown in FIG. 4, the shielded solid electric wire 1 is manufactured through a laminating step S1 and a compression step S2.

The laminating step S1 is a step of providing the inclusion 30 on the outer periphery of the solid electric wire 10 and providing the conductive metal tube 20 on the outer periphery of the inclusion 30. The laminating step S1 includes a first laminating step S11 and a second laminating step S12.

The first laminating step S11 is a step of providing the inclusion 30 on the outer periphery of the solid electric wire 10. In the first laminating step S11, the tape-shaped inclusion 30 is wrapped around the solid electric wire 10, for example, in a spiral shape or longitudinally wrapped. In this step, the inclusion 30 is wrapped around the insulator 12 in at least one layer.

Further, the inclusion 30 may be provided with an adhesive layer or a bonding layer in a part or an entire region to maintain a wrapped state after the wrapping. In this step, when the inclusion 30 has a configuration of two or more layers, a material having a melting point higher than that of the insulator 12 or an ignition point temperature of 250°C or higher is preferably wrapped to face the outermost layer.

In the second laminating step S12, the metal tube 20 is provided on an outer periphery of the laminate L1 obtained in the first laminating step S11. As shown in FIG. 4, the second laminating step S12 is a step of wrapping the metal plate MP around the outer periphery of the laminate L1 and welding the overlapping portion LP of the wrapped metal plate MP. Alternatively, the second laminating step S12 is a step of wrapping the metal plate MP around the outer periphery of the laminate L1 and welding the end portions E of the wrapped metal plate MP.

Here, in the second laminating step S12, since the inclusion 30 is provided on the outer periphery of the solid electric wire 10, the insulator 12 is less likely to be damaged by sparks or heat during the welding. Therefore, the necessity of performing welding to avoid the insulator 12 from being damaged is reduced, and the welding work is easily performed.

Further, a possibility that the insulator 12 is damaged by the burrs B generated after the second laminating step S12 can also be reduced. For example, in the example shown in FIG. 2, when the metal plate MP is thin, there is a possibility that the burrs B may penetrate the metal plate MP on a lower side. However, since the shielded solid electric wire 1 according to the present embodiment includes the inclusion 30 on an inner side of the metal tube 20, the possibility that the insulator 12 is damaged by the burrs B can be reduced.

Further, in the example shown in FIG. 3, since there is no metal plate MP entering the lower side, the possibility that the insulator 12 is damaged by the burrs B generated during the welding is higher than in the example shown in FIG. 2. However, when the shielded solid electric wire 1 includes the inclusion 30, the insulator 12 can be less likely to be damaged even in such a case.

Reference is made to FIG. 4 again. When the laminating step S1 is completed, the compression step S2 is performed. The compression step S2 is a step of compressing a laminated body L2 formed in the laminating step S1 from around the solid core conductor 11 inward. In the compression step S2, a die D including two first rollers R1 that can be compressed inward in a width direction and two second rollers R2 that can be compressed inward in a thickness direction is used. The laminated body L2 is compressed inward from around in the process of passing between the rollers R1 and R2. Thus, the shielded solid electric wire 1 shown in FIGS. 1 and 2 or 3 is obtained.

Here, in the example shown in FIG. 4, the laminated body L2 is compressed in the width direction first by the first rollers R1 in the compression step S2, but is not limited thereto, and may be compressed in the thickness direction first by the second rollers R2. When being first compressed in the thickness direction by the second rollers R2, the laminated body L2 first has a shape slightly bulging in the width direction. Therefore, since the laminated body L2 is compressed by the first rollers R1 later in a shape pointed in the width direction, the first rollers R1 need to exert excessive compressive forces. Therefore, in the compression step S2, as shown in FIG. 4, the laminated body L2 is preferably first compressed by the first rollers R1 in the width direction, and then compressed by the second rollers R2 in the thickness direction. Further, it is also preferable that the first rollers R1 and the second rollers R2 are provided at the same positions in a conveyance direction of the laminated body L2, and the compression is simultaneously performed in the width direction and the thickness direction. In this case, the laminated body L2 can be compressed from an entire periphery, and a possibility that the metal tube 20 of the shielded solid electric wire 1 expands in either the width direction or the thickness direction can be reduced.

In this way, according to the shielded solid electric wire 1 and the manufacturing method therefor according to the first embodiment, the inclusion 30 formed to include a material having a melting point higher than that of the insulator 12 or an ignition point temperature of 250°C or higher is provided on the outer periphery of the solid electric wire 10. Therefore, the inclusion 30 is less likely to melt and ignite than the insulator during the welding. Thus, the insulator 12 can be less likely to be damaged during the welding. Further, the burrs B generated during the welding are less likely to reach the insulator 12, and protection can be performed. Accordingly, it is possible to provide the shielded solid electric wire 1 capable of improving manufacturability and protecting the insulator 12 even if the burrs B are generated during the welding, and the manufacturing method therefor.

When the inclusion 30 is formed to include a material having a Young's modulus lower than that of the insulator 12, elasticity of the inclusion 30 can be used to reduce stress applied to the insulator 12 during bending of the shielded solid electric wire 1.

Further, when the inclusion 30 is formed to include a material having a heat-resistant temperature of 550°C or higher, even if the insulator 12 is damaged or melted, a short circuit between the solid core conductor 11 and the metal tube 20 can be easily prevented by the inclusion 30.

Although the present disclosure is described above based on the embodiment, the present disclosure is not limited to the embodiment described above; modifications may be made without departing from the gist of the present disclosure, and a publicly known or well-known technique may be combined.

For example, in the above embodiment, the inclusion 30 may be a sheet member having a multilayer structure including a conductive metal layer and an insulating resin film. In this case, by providing the metal layer inward of the resin film, the solid electric wire 10 can exhibit a shielding function of two layers including the metal layer and the metal tube 20, and a shielding performance can be improved by multiple reflections. In this case, the resin film may be made of a material having a melting point higher than that of the insulator 12 or an ignition point temperature of 250°C or higher, or a layer of the material may be formed further outward of the resin film.

In the above embodiment, the inclusion 30 is wrapped on the solid electric wire 10, but is not particularly limited thereto, and may be formed in a tubular shape in advance and provided on the solid electric wire 10 by inserting the solid electric wire 10.

In the above embodiment, the solid core conductor 11 is implemented by a busbar that is a flat metal plate, but is not particularly limited thereto, and may have another shape, such as a cylindrical shape having a circular cross-section. In this case, the solid core conductor 11 also preferably has a cross-sectional area of 3mm² or more and 300 mm² or less, more preferably 10 mm² or more, and still more preferably 100 mm² or more. Further, when the solid core conductor 11 is formed to have a circular cross-section by a set of a plurality of metal members, the cross-sectional areas of the metal members preferably satisfy the above condition. Further, when the solid core conductor 11 has a circular cross-section or the like, the compression step S2 is performed inward from around according to the shape.

What is claimed is:

1. A shielded solid electric wire comprising:
a solid electric wire including a solid core conductor made of a conductive metal and an insulator covering the solid core conductor;
a conductive metal tube provided around the solid electric wire and made into a tubular shape having a burr formed during welding; and
an inclusion provided between the solid electric wire and the metal tube and formed to include a material having a melting point higher than that of the insulator or an ignition point temperature of 250°C or higher.

2. The shielded solid electric wire according to claim 1, wherein
the inclusion is formed to include a material having a Young's modulus lower than that of the insulator.

3. The shielded solid electric wire according to claim 1, wherein
the inclusion is formed to include a material having a heat-resistant temperature of 550°C or higher.

4. The shielded solid electric wire according to claim 1, wherein
the inclusion is a sheet member having a multilayer structure including a conductive metal layer and an insulating resin film, and the metal layer is disposed inward of the resin film.

5. A method for manufacturing a shielded solid electric wire, the method comprising:
forming a laminate by providing, on an outer periphery of a solid electric wire including a solid core conductor made of a conductive metal and an insulator covering the solid core conductor, an inclusion formed to include a material having a melting point higher than that of the insulator or an ignition point temperature of 250°C or higher;
forming a laminated body by performing welding such that a metal plate is wrapped on the formed laminate to make the metal plate into a tubular shape; and
compressing the formed laminated body inward from around the solid core conductor.
